(19) United States
(12) Patent Application Publication
(10) Pub. No.: US 2026/0042447 A1
(43) Pub. Date: Feb. 12, 2026

(54) METHOD, APPARATUS, CONTROLLER, VEHICLE AND PRODUCT FOR DRIVING A VEHICLE

(71) Applicant: Robert Bosch GmbH, Stuttgart (DE)

(72) Inventors: Xueshi Dong, Suzhou (CN); Bo Wang, Suzhou (CN)

(21) Appl. No.: 19/293,238

(22) Filed: Aug. 7, 2025

(30) Foreign Application Priority Data
Aug. 12, 2024 (CN) 2024 1110 1634.6

(51) Int. Cl. B60W 30/18; B60W 10/04; B60W 10/22; B60W 50/14

(52) U.S. Cl. CPC B60W 30/18172; B60W 10/04; B60W 10/22; B60W 50/14; B60W 2510/227; B60W 2520/10; B60W 2520/26; B60W 2520/28; B60W 2540/215; B60W 2710/22

(57) ABSTRACT

A method, an apparatus, a controller, a vehicle, and a computer program product for driving a vehicle are disclosed. The method includes (i) controlling the vibration of the vehicle through an active suspension of the vehicle according to a control instruction, (ii) applying a compensation torque to the vehicle in response to the vehicle being vibrated, and (iii) driving the vehicle based at least on the compensation torque. In this way, the vibration effect of the active suspension can help enhance the friction between the vehicle and the ground. During the vibration process, a torque can be applied—for example, a compensation torque when the vehicle vibrates to its lowest point. This approach aids the vehicle in traversing challenging road surfaces, such as slippery slopes or mud pits.

This application claims priority under 35 U.S.C. § 119 to application no. CN 2024 1110 1634.6, filed on Aug. 12, 2024 in China, the disclosure of which is incorporated herein by reference in its entirety.

The present disclosure relates to the field of vehicles, and more particularly, to a method, an apparatus, a controller, a vehicle, and a computer program product for driving a vehicle.

### BACKGROUND

With the rise of outdoor adventure and extreme sports, off-road activities have become a popular challenge for many vehicle enthusiasts. From vast deserts to rugged mountains and muddy swamps, off-road enthusiasts drive a variety of vehicles, enjoying the unique thrill of exploring the unknown and conquering nature.

Each type of terrain presents its own distinct physical characteristics and challenges. These include the risk of getting stuck in sand, the scratches and impacts from rocks, the slipping of tires in mud, and the buoyancy of water flow-all of which pose significant tests to the capabilities of both vehicles and drivers.

### SUMMARY

Examples of the present disclosure provide a method, an apparatus, a controller, a vehicle, and a computer program product for driving a vehicle. In a first aspect of the present disclosure, a method for driving a vehicle is provided. The method comprises controlling the vibration of the vehicle through an active suspension of the vehicle according to a control instruction. The method further comprises applying a compensation torque to the vehicle in response to the vehicle being vibrated. The method also comprises driving the vehicle based at least on the compensation torque.

In a second aspect of the present disclosure, an apparatus is provided. The apparatus comprises a vibration module configured to control the vibration of the vehicle through an active suspension of the vehicle according to a control instruction. The apparatus further comprises a compensation torque module configured to apply a compensation torque to the vehicle in response to the vehicle being vibrated. The apparatus also comprises a drive module configured to drive the vehicle based at least on the compensation torque.

In a third aspect of the present disclosure, a controller is provided, comprising: at least one processor; and a memory coupled to the at least one processor and having instructions stored thereon that, when executed by the at least one processor, cause the controller to execute the method according to the first aspect of the present disclosure.

In a fourth aspect of the present disclosure, a computer program product is provided, which is tangibly stored on a non-transitory computer-readable medium and comprises machine-executable instructions, which, when executed, cause a machine to perform the method according to the first aspect of the present disclosure.

In a fifth aspect of the present disclosure, a computer-readable storage medium is provided, having machine-executable instructions stored thereon, which, when executed by a processor, implement the method according to the first aspect of the present disclosure.

In a sixth aspect of the present disclosure, a vehicle is provided, comprising the controller according to the third aspect of the present disclosure.

It will be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same reference number typically represents the same parts.

FIG. 1A is a schematic diagram of an exemplary environment in which multiple examples of the present disclosure may be implemented;

FIG. 1B is a schematic diagram of an application scenario of a method for driving a vehicle according to an example of the present disclosure;

FIG. 2 is a flow chart of a method for driving a vehicle according to an example of the present disclosure;

FIG. 3 is a diagram of application process of a method according to an example of the present disclosure;

FIG. 4 is a diagram of an application architecture of a method for driving a vehicle according to an example of the present disclosure;

FIG. 5 is a schematic diagram of the relationship between amplitude and compensation torque according to an example of the present disclosure;

FIG. 6 is a schematic diagram of a reminder apparatus according to an example of the present disclosure; and

FIG. 7 is a schematic block diagram of an exemplary device according to an example that is suitable to embody the content of the present disclosure.

In the various accompanying drawings, the same or corresponding numbers represent the same or corresponding portions.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to.” The term “based on” should be understood as “at least partially based on.” The term “one example” or “this example” should be understood as “at least one example.” The terms “first,” “second,” etc. may refer to different or the same object. Other explicit and implicit definitions may be included below.

When a vehicle encounters a slippery, uneven road surface, part of the vehicle body may become trapped in a slippery pit. In existing methods, the driver can only resort to applying excessive torque or increasing the throttle. At this point, due to the very low friction coefficient, these approaches often prove ineffective and can even exacerbate the slipperiness of the road, making it more challenging for the vehicle to escape the pit.

Additionally, a vehicle may not necessarily fall into a pit but can encounter other road conditions with similarly low friction coefficients. For instance, when climbing a slope, the vehicle may struggle to ascend a particular section due to the limited friction between the tires and the road surface. However, in existing methods, the driver can only resort to applying excessive torque or increasing the throttle, making it difficult to traverse such low-friction surfaces (e.g., slippery areas).

In this regard, the present disclosure proposes a method for driving a vehicle, which involves controlling the vibration of the vehicle through an active suspension of the vehicle according to a control instruction. The method further comprises applying a compensation torque to the vehicle in response to the vehicle being vibrated. The method also comprises driving the vehicle based at least on the compensation torque. According to examples of the present disclosure, the vibration effect of the active suspension, used for shock absorption, is utilized to adjust the pressure of the vehicle on the road surface. By applying torque based on this adjusted pressure, the method can enhance friction between the vehicle and the ground, thereby effectively assisting the vehicle in traversing sections with lower friction coefficients.

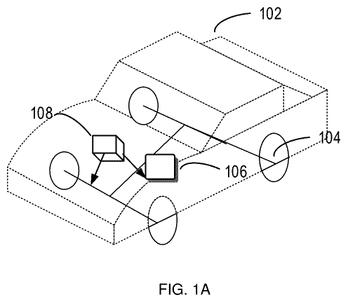

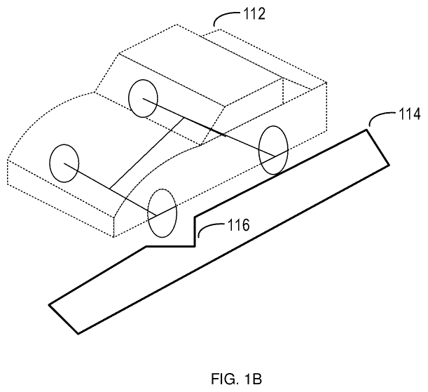

The examples of the present disclosure will be described in detail below with reference to the accompanying drawings, wherein FIG. 1A is a schematic diagram of an exemplary environment 100 in which multiple examples of the present disclosure may be implemented. As shown in FIG. 1A, the exemplary environment 100 comprises a vehicle 102, an active suspension 104 on the vehicle 102, an engine 106 on the vehicle 102, and a vehicle control unit 108 deployed on the vehicle 102. In this example, the execution entity of the method is the vehicle control unit 108.

In this example, the vehicle control unit 108 controls the vibration of the vehicle 102 through the active suspension 104 of the vehicle 102 according to a control instruction. The active suspension is a suspension system that can be actively and dynamically adaptively adjusted according to the driving conditions of the vehicle. This system is usually used to actively adjust the stiffness and damping characteristics of the suspension according to external conditions such as the vehicle's motion state and road conditions, thereby optimizing the vehicle's ride comfort and handling stability. However, in various examples of the present disclosure, the active suspension 104 is not used to control the vibration of the vehicle 102 for the purpose of shock absorption. On the contrary, the active suspension 104 is used to adjust the pressure of the vehicle on the road surface, thereby increasing the friction between the vehicle and the ground.

It should be understood that the examples of the present disclosure do not limit the type and configuration of the active suspension 104, as long as the vibration effect of the active suspension can be exerted. For example, the active suspension 104 can be a full active suspension, a slow active suspension, a semi-active suspension, or an energy-regenerative active suspension. The full active suspension is also called a bandwidth active suspension, which can adjust the stiffness and damping of the suspension in a timely manner. The full active suspension considers the vehicle's smoothness and handling stability across the entire frequency range of body vibrations. It can control the vehicle's height in real time, enhance passability, reduce wheel load fluctuations, improve adhesion performance, enhance handling, and decrease tire wear. The slow active suspension, also known as a limited bandwidth active suspension, features an actuator that operates within a narrow frequency range, resulting in lower cost and complexity. This system actively controls the primary vibrations of the vehicle body, encompassing the necessary frequency ranges for longitudinal, pitch, roll, and steering control. It enhances driving performance near the vehicle's resonance frequency and improves the control of the vehicle's posture. For example, the active hydraulic shock absorber is equipped with a hydraulic pump that can actively pump hydraulic oil into the shock absorber, allowing for adjustments in the active suspension's height based on specific settings.

Semi-active suspension refers to a system in which either the stiffness of the suspension's elastic elements or the damping coefficient of the shock absorbers can be adjusted and controlled as needed. Since adjusting spring stiffness is relatively challenging, most semi-active suspensions only focus on altering the damping characteristics insteading of the stiffness of the suspension. The semi-active suspension can be further classified into stepped and stepless types based on the levels of damping. The semi-active suspension has no power source and consists only of controllable damping elements. The energy-regenerative active suspension integrates energy regeneration and damping functions. This type of suspension features an energy recovery apparatus that converts the vibration energy dissipated by the shock absorbers into usable energy for other components of the vehicle, all while maintaining a smooth driving experience. The energy-regenerative suspension can be categorized into two types based on implementation methods: mechanical energy regeneration and electromagnetic energy regeneration. The key feature of the energy-regenerative active suspension is its ability to capture and convert vehicle vibration energy of the vehicle into usable energy for other components, contributing to overall vehicle energy efficiency.

If the vehicle 102 is vibrated, the vehicle control unit 108 controls the engine 106 to apply a compensation torque to the vehicle 102. Torque is a special moment that causes an object to rotate. The torque applied by the engine 106 refers to the torque output by the engine 106 from the crankshaft end (not shown). Its exact definition is the cross product (M) of the position vector (L) and the force (F). In physics, it refers to the force that causes an object to rotate multiplied by the distance to the axis of rotation. It can represent the magnitude of the force output by the engine (because the radius of the crankshaft in the engine is constant). Under the condition of fixed power, it is inversely proportional to the speed of the engine 106. The faster the speed, the smaller the torque, and vice versa. It reflects the load capacity of the vehicle 102 within a certain range. External torque is also called torque or external couple moment, while internal torque is referred to as internal couple moment or simply torque. For example, the vehicle control unit 108 may control the engine 106 to reduce a certain speed to apply a compensation torque to the vehicle 102.

According to examples of the present disclosure, the vehicle control unit 108 drives the vehicle 102 based at least on the compensation torque. For a family car, the greater the torque, the better the acceleration; for an off-road vehicle, the greater the torque, the greater the gradeability; for a truck, the greater the torque, the greater the weight the vehicle can pull. By compensating the torque, the vehicle 102 may travel through a road section with a smaller friction coefficient.

It should be noted that the vehicle control unit 108 may have independent hardware devices to complete the above operations in the vehicle 102, or may receive the results of the operations from an external device of the vehicle 102 that completes the above operations through a communication module. In other words, the above operations may be implemented in a cloud computing environment. The vehicle control unit 108 may have an independent physical server, a server cluster composed of multiple physical servers, or a distributed system. It may also be connected to cloud servers providing basic cloud computing services such as cloud services, cloud databases, cloud computing, cloud functions, cloud storage, network services, cloud communications, middleware services, domain name services, security services, as well as big data and artificial intelligence platforms, to accomplish the above operations.

FIG. 1B is a schematic diagram of an application scenario of a method for driving a vehicle according to an example of the present disclosure. In this example, the vehicle 112 is traveling on a flat road surface 114 and is stuck in a mud pit 116. The mud pit 116 is deep and slippery, so that the vehicle 112 cannot drive out of the mud pit 116 simply by increasing the torque or increasing the throttle. In this case, the vehicle control unit (not shown) on the vehicle 112 controls the vibration of the vehicle through the active suspension of the vehicle 112 according to a control instruction. If the vehicle is vibrated, the vehicle control unit applies a compensation torque to the vehicle 112 through the engine, and drives the vehicle 112 out of the mud pit 116 based at least on the compensation torque. The scenario shown in FIG. 1B shows a vehicle 112 stuck in a mud pit 116. However, the method of the examples of the present disclosure is not limited to this situation. For example, the method of the examples of the present disclosure may also be applied to climbing scenarios and situations where the road is slippery on a flat surface, even if the vehicle is not stuck in a mud pit.

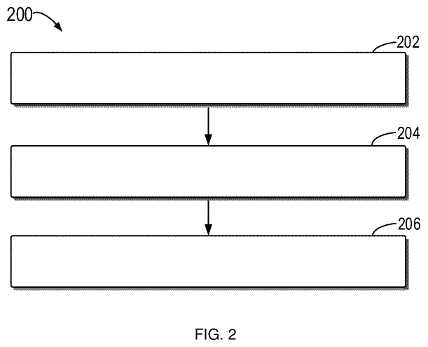

The above describes an exemplary environment 100 in which an example of the present disclosure can be implemented and an application scenario of a method for driving a vehicle in conjunction with FIG. 1A and FIG. 1B. The following describes a flow chart of a method 200 for driving a vehicle according to examples of the present disclosure in conjunction with FIG. 2. The method of this example may be executed by a control system deployed on a vehicle, such as a vehicle control unit, like a Cruise Control for Off-Road (CCO) system. At block 202, the vehicle control unit controls the vibration of the vehicle through the active suspension of the vehicle according to a control instruction. The control instruction is an instruction obtained from a user, or it can be a control instruction automatically determined by the vehicle according to the road conditions. For example, the vehicle control unit generates a control instruction based on real-time data from a sensor, by analyzing the current road conditions and vehicle status through an algorithm. This instruction specifies in detail how the active suspension should be adjusted (such as increasing or decreasing damping, adjusting the suspension height) to achieve the vibration of the vehicle. The vehicle can be any type of vehicle, such as an off-road vehicle, a sedan, a truck, etc. The active suspension used may be various active suspensions 104 listed in detail in FIG. 1A, which are generally used to actively adjust the stiffness and damping characteristics of the suspension, thereby optimizing the ride comfort and handling stability of the vehicle. However, in various examples of the present disclosure, the active suspension is not used to control the vibration of the vehicle for the purpose of shock absorption. On the contrary, the active suspension is used to adjust the pressure of the vehicle on the road surface, thereby increasing the friction between the vehicle and the ground. This provides a basis for the effect of applying the compensation torque later.

At block 204, if the vehicle is vibrated, the vehicle control unit applies a compensation torque to the vehicle. The drive system receives the compensation torque instruction and applies a corresponding compensation torque to the tires by adjusting the engine output. In this way, when the vehicle is vibrating, the additional force provided by the engine to the tires can be controlled. When the vehicle experiences vibrations, physical principles dictate that the pressure exerted by the vehicle on the tires' contact surface (such as the ground or a mud pit) will be adjusted, such as increasing over a period of time. Therefore, applying a compensation torque to the vehicle may help adjust its friction. As shown in FIG. 1B, for example, when the vehicle 112 moves toward the ground, the pressure of the vehicle 112 on the mud pit 116 is continuously increased. At this time, if a torque (i.e., a compensation torque) is applied to the vehicle 112 by, for example, the engine 106 of FIG. 1A, the friction of the vehicle 112 on the mud pit 116 may be increased, which helps the vehicle to drive out of the mud pit 116.

At block 206, the vehicle control unit drives the vehicle based at least on the compensation torque. The vehicle may travel based on the power provided by the compensation torque, or it may travel partly based on the compensation torque and partly based on the torque provided by other functions or modes. The vehicle may drive out of the slippery road section based on the increased friction. The example shown in FIG. 2 may be applied to the application scenario shown in FIG. 1B to travel through a road surface with a low friction coefficient, such as a mud pit, a slope, etc.

According to examples of the present disclosure, the vibration effect of the active suspension, used for shock absorption, is utilized to adjust the pressure of the vehicle on the road surface. By applying torque based on this adjusted pressure, the method can enhance friction between the vehicle and the ground, thereby effectively assisting the vehicle in traversing sections with lower friction coefficients.

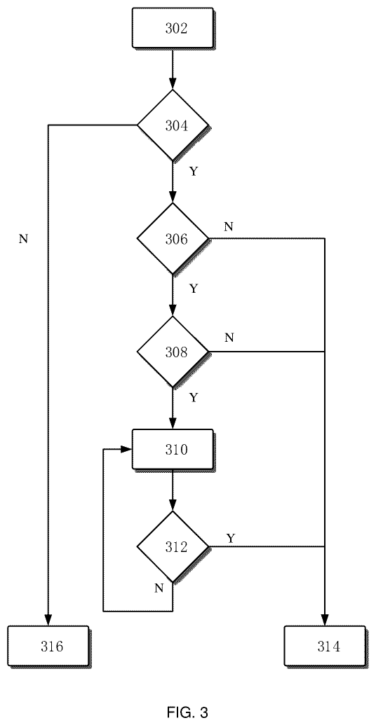

FIG. 3 is a diagram of application process of a method according to an example of the present disclosure. The method according to the examples of the present disclosure may be deployed in a vehicle control system, for example, in a cruise control system, and applied according to the application process shown in FIG. 3. As shown in FIG. 3, the process starts at 302. At 304, it is determined whether the CCO system is started. If not, a prompt is provided to the user whether to start the CCO system and the process proceeds to 316 to continue shutting down the driving function. If it is already started, the process proceeds to 306 to determine whether a control instruction needs to be provided.

Different initiation conditions may be set at 306. In some examples, whether to provide a control instruction to drive the vehicle is determined based on the slip rate of the vehicle. This example comprises obtaining the rotation speed and driving speed of the tires of the vehicle based on a user instruction (e.g., the user presses an accept button in the prompt for starting the CCO system presented at 304) before controlling the vibration of the vehicle through the active suspension of the vehicle. If the rotation speed and the driving speed are inconsistent, it means that the tires of the vehicle have a certain amount of idling, which may be caused by factors such as slippery ground. The user instruction may be, for example, an instruction input by the user. This example further comprises determining the absolute value of the difference between the rotation speed and the driving speed as the slip speed. This example also comprises determining the ratio of the slip speed to the driving speed as the slip ratio. This example also comprises detecting whether the slip ratio is greater than a first threshold. This example also comprises providing a control instruction if the slip ratio is greater than the first threshold. According to the method of this example, when facing special road surfaces such as slippery roads, it is possible to automatically and accurately determine when the vehicle vibration should be controlled and the compensation torque should be applied without manual intervention.

Referring back to FIG. 3, if it is determined at 306 that it is not necessary to provide a control instruction to drive the vehicle, the drive function is maintained in a ready state at 314 so that the user may start it at any time. If it is determined at 306 that it is necessary to provide a control instruction to drive the vehicle, the process proceeds to 308 to determine whether to start the drive function. For example, it may be determined whether to start the drive function based on the user's input. If it is started, the process proceeds to 310 to perform the operations at blocks 202-206 of FIG. 2. If it is not started, the drive function is maintained in a ready state at 314 so that the user may start it at any time. At 310, the vibration of the vehicle is controlled through the active suspension of the vehicle according to the control instruction. If the vehicle is vibrated, a compensation torque is applied to the vehicle, and the vehicle is driven based at least on the compensation torque.

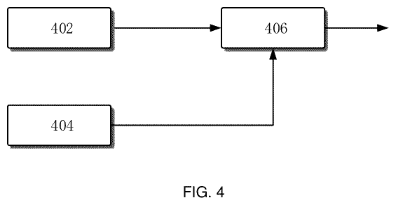

FIG. 4 is a diagram of an application architecture of a method for driving a vehicle according to an example of the present disclosure. As shown in FIG. 4, the Traction Control System (TCS) 402 measures the slip rate of the vehicle in real time according to the user instruction, and when the slip rate reaches a preset threshold, provides a control instruction to the cruise control system 406, requesting the application of the operation shown in FIG. 1. Moreover, the active suspension 404 of the vehicle is equipped with a height sensor, which measures the height of the vehicle chassis from the target object below (such as the ground) in real time, and transmits the height to the CCO system 406. The CCO system 406 determines whether vibration is required and the amplitude of vibration (to prevent the chassis from hitting the target object below) according to the slip rate and height, and applies torque.

Referring back to FIG. 3, after driving the vehicle once at 310, the process proceeds to 312 to determine whether the driving function needs to be turned off, such as determining whether the user presses a button to stop the driving function or whether the user steps on the brake. If the driving function does not need to be turned off, the process returns to 310 and repeats these operations once to continuously drive the vehicle out of a special road surface such as one with a low friction coefficient. If the driving function needs to be turned off, the process proceeds to 314 to stop applying the compensation torque to the vehicle and keep the driving function in a ready state so that the user can start it at any time. This helps the user to fully control the vehicle.

When the vehicle vibrates, it involves the amplitude at which the vibration occurs. In some examples, a vibration period and a maximum amplitude are provided, and the vehicle vibration is controlled according to the dynamic amplitude through an active suspension, wherein the magnitude of the dynamic amplitude is positively correlated with time. The dynamic amplitude refers to the amplitude of the vehicle that is constantly and dynamically changing. This example also comprises if the dynamic amplitude is equal to the maximum amplitude, the vehicle vibration is controlled according to the maximum amplitude through an active suspension. When the vibration begins, the amplitude gradually increases. This slow ramp-up is beneficial for maintaining the stability between the vehicle and the ground, preventing the sudden vibration from causing the vehicle to become misaligned and helping to avoid panic for the driver. The amplitude of the vehicle is limited by the maximum amplitude, which may prevent excessive and violent vibration of the vehicle.

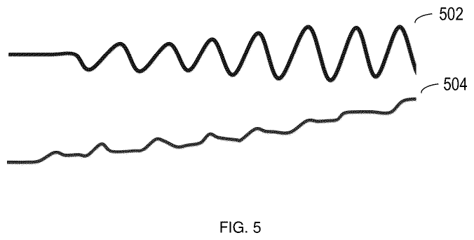

FIG. 5 is a schematic diagram of the relationship between amplitude and compensation torque according to an example of the present disclosure. The curve 502 in FIG. 5 is a curve showing the change of amplitude, and curve 504 is a curve showing the change of compensation torque. The horizontal axes of the two curves 502 and 504 indicate time, and the vertical axes indicate magnitude. It can be seen from the curve 502 that the amplitude of the vehicle increases slowly with the increase of time, and the two are positively correlated until the maximum amplitude is reached and remains unchanged. This slow increase is beneficial to the stability of the relationship between the vehicle and the ground. Correspondingly, it can be seen from the curve 504 that the output compensation torque also increases continuously with the increase of amplitude. Therefore, the increased friction may be fully utilized to drive out of a special road surface.

The maximum amplitude may be preset or measured. For example, a sensor is used to measure the distance between the vehicle and a target object under the vehicle, and the maximum amplitude is set to a value smaller than the distance, so that the vehicle will not damage the chassis due to hitting the ground during vibration. In the present disclosure, the target object under the vehicle includes the ground and other objects, such as stones. The sensor used for measurement may be of various types, and the present disclosure does not limit this.

During the vibration of the vehicle, the output compensation torque may be flexibly set at the time level. During the vibration of the vehicle, there are peak and trough. In some examples, at the first moment when the active suspension vibrates from a peak to a through, the compensation torque is continuously applied to the vehicle. The first moment is any moment from the peak to the trough. During this vibration, the vehicle moves toward the ground, so the pressure of the vehicle on the ground is constantly increasing. Applying the compensation torque at this time may increase the friction of the vehicle and help the vehicle get out of the slippery road.

This example also comprises stopping applying the compensation torque to the vehicle at the second moment when the active suspension vibrates from the trough to the peak. The second moment is any moment from the trough to the peak. During this vibration, the vehicle moves in a direction away from the ground, so the pressure of the vehicle on the ground is constantly decreasing. Stopping the application of the compensation torque at this time may reduce the waste of power. In this example, by using the law of the change of the pressure on the ground during the vibration of the vehicle, setting the output compensation torque according to the examples of the present disclosure may help the vehicle to traverse a section with a smaller friction coefficient. For example, the dynamic amplitude may be set according to formula (1).

$$L = t \times Sin ( B \times t ) \qquad Formula ( 1 )$$

L is the amplitude, t is the time, B is the vibration period, and Sin( ) is the sine function. Before reaching the maximum amplitude, the active suspension may slowly increase the dynamic amplitude of the vehicle according to formula (1). The larger B is, the greater the vibration frequency of the vehicle is.

In addition, the output compensation torque may be flexibly set in terms of distance. In some examples, the compensation torque is continuously applied to the vehicle at a certain distance before the active suspension vibrates to the trough. During this vibration, the vehicle moves toward the ground, so the pressure of the vehicle on the ground is constantly increasing. Applying the compensation torque at this time may increase the friction of the vehicle and help the vehicle get out of the slippery road. This example also comprises stopping the application of the compensation torque to the vehicle at another distance before the active suspension vibrates to the peak. During this vibration, the vehicle moves in a direction away from the ground, so the pressure of the vehicle on the ground is constantly decreasing. Stopping the application of the compensation torque at this time may reduce the waste of power. The vehicle may anticipate the amplitude in advance, and then use the height sensor (such as one configured on the active suspension) to try to measure the height of the chassis without calculating the vibration moment of the vehicle. In this example, by using the law of the change of the pressure on the ground during the vibration of the vehicle, setting the output compensation torque according to the examples of the present disclosure may help the vehicle to traverse a section with a smaller friction coefficient.

The present disclosure further provides an example of how to calculate the compensation torque. The example comprises determining the compensation torque based at least on the maximum amplitude, wherein the magnitude of the compensation torque is positively correlated with the maximum amplitude. That is, the larger the amplitude, the larger the output compensation torque. This can increase the friction of the vehicle and help the vehicle get out of a slippery road.

In addition to the amplitude, the compensation torque may also be determined based on the instantaneous speed of the vibration. In some examples, the height of the vehicle at the current moment and the height at the previous moment are measured, and the vibration speed of the vehicle is determined based on the height at the current moment and the height at the previous moment, and the compensation torque is determined based at least on the vibration speed, wherein the magnitude of the compensation torque is positively correlated with the vibration speed of the vehicle. In this example, the height data measured by the height sensor configured on the active suspension may be used to calculate the speed of the vehicle when it vibrates.

When the vibration speed is faster and the vehicle moves toward the ground, the pressure is relatively large. At this point, increasing the compensation torque is beneficial for the vehicle to traverse special road surfaces, such as smooth road surfaces. In some examples, the above key factors may also be integrated. For example, the final torque to be output may be determined according to formula (2).

$$H 1 = H 2 \times a + L \times b \qquad Formula ( 2 )$$

H1 is the final torque to be output, H2 is the vibration speed of the vehicle (i.e., the descent speed or the ascent speed) determined based on the height at the current moment and the height at the previous moment, a is a preset coefficient, L is the amplitude of the vehicle, and b is another preset coefficient. Formula (2) provides a solution that integrates different key factors, which can calculate a more appropriate torque, thereby helping the vehicle to drive off a road with a low friction coefficient.

Other driving functions are often deployed on the vehicle, such as an automatic cruise function. This function may be applied to the same subject as the examples of the present disclosure. That is, both may be executed by a control system deployed on the vehicle, such as a vehicle control unit, like a Cruise Control for Off-Road (CCO) system. If the function enabled by the user also involves providing torque, for example, the function may provide a separate torque in real time based on the speed, acceleration, etc. of the vehicle. That is, the torque output by the method of the examples of the present disclosure may be superimposed on the torque provided by other functions. For example, in the automatic cruise function, the vehicle may automatically determine a torque based on the vehicle's driving speed and acceleration control deviation, and then determine a compensation torque according to the examples of the present disclosure, and use the sum of the two torques as the final output torque.

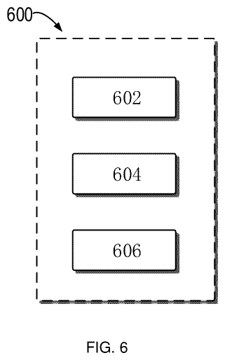

FIG. 6 is a schematic diagram of a reminder device according to an embodiment of the present disclosure. In the apparatus 600 shown in FIG. 6, a vibration module is comprised, configured to control the vibration of the vehicle through an active suspension of the vehicle according to a control instruction. The apparatus 600 further comprises a compensation torque module configured to apply a compensation torque to the vehicle in response to the vehicle being vibrated. The apparatus 600 also comprises a drive module configured to drive the vehicle based at least on the compensation torque.

In some examples, the apparatus 600 further comprises a speed acquisition module configured to acquire the rotation speed and the driving speed of the tires of the vehicle according to a user instruction. The apparatus 600 further comprises a first determination module configured to determine the absolute value of the difference between the rotation speed and the driving speed as the slip speed. The apparatus 600 further comprises a second determination module configured to determine the ratio of the slip speed to the driving speed as the slip rate. The apparatus 600 further comprises a detection module configured to detect whether the slip rate is greater than a first threshold. A first providing module configured to provide a control instruction in response to the slip rate being greater than the first threshold.

In some examples, the apparatus 600 further comprises a prompt module configured to present a prompt to the user to use the first driving function. The apparatus 600 further comprises a second providing module configured to provide a user instruction in response to the user accepting the prompt.

In some examples, the vehicle is configured with a vibration period and a maximum amplitude, and the vibration module 602 comprises a dynamic control module configured to control the vibration of the vehicle according to the dynamic amplitude through active suspension, wherein the magnitude of the dynamic amplitude is positively correlated with time. The vibration module 602 also comprises a maximum control module configured to control the vehicle vibration according to the maximum amplitude through active suspension in response to the dynamic amplitude being equal to the maximum amplitude.

In some examples, the compensation torque module 604 comprises a first applying module configured to continuously apply the compensation torque to the vehicle starting at a first moment when the active suspension vibrates from a peak to a trough. The compensation torque module 604 also comprises a first stopping module configured to stop applying the compensation torque to the vehicle starting at a second moment when the active suspension vibrates from a trough to a peak.

In some examples, the compensation torque module 604 comprises a second applying module configured to continuously apply the compensation torque to the vehicle at a first distance before the active suspension vibrates to a trough. The compensation torque module 604 also comprises a second stopping module configured to stop applying the compensation torque to the vehicle at a second distance before the active suspension vibrates to a peak.

In some examples, the first applying module comprises a third determination module configured to determine the compensation torque based at least on the maximum amplitude, wherein the magnitude of the compensation torque is positively correlated with the maximum amplitude.

In some examples, the first applying module comprises a first measurement module configured to measure the height of the vehicle at a current moment and the height at a previous moment. The first applying module also comprises a fourth determination module configured to determine the vibration speed of the vehicle based on the height at the current moment and the height at the previous moment. The first applying module also comprises a fifth determination module configured to determine the compensation torque based at least on the vibration speed, wherein the magnitude of the compensation torque is positively correlated with the vibration speed of the vehicle.

In some examples, the apparatus 600 further comprises a second measurement module configured to measure the distance between the vehicle and the target object under the vehicle using a sensor. The apparatus 600 further comprises a sixth determination module configured to determine a maximum amplitude based on the distance, wherein the maximum amplitude is less than the distance.

In some examples, the apparatus 600 further comprises a third stopping module configured to stop applying the compensation torque to the vehicle in response to receiving a stop instruction from a user.

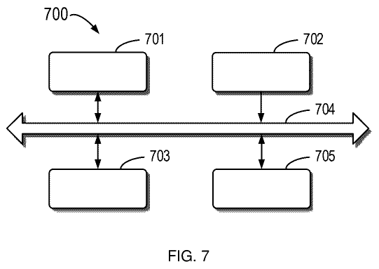

FIG. 7 is a schematic block diagram of a controller 700 suitable for implementing the examples of the present disclosure. As shown in the figure, the controller 700 comprises a processor 701, which can perform various appropriate actions and processes according to computer program instructions stored in a read-only memory (ROM) 702 and loaded into a random-access memory (RAM) 703. Various programs and data required for the operation of the controller 700 may also be stored in the RAM 703. The processor 701, the ROM 702, and the RAM 703 are interconnected through a bus 704. An input/output (I/O) interface 705 is also connected to the bus 704.

The various methods and processes described above may be executed by the processor 701. For example, in some examples, the various methods and processes described above may be implemented as computer software programs tangibly embodied in a machine-readable medium. In some examples, part or all of the computer programs may be loaded and/or installed onto the controller 700 through the ROM 702. When the computer program is loaded into the RAM 703 and executed by the processor 701, one or more actions of the methods and processes described above may be performed.

The present disclosure may be a method, an apparatus, a system and/or a computer program product. The computer program product may comprise a computer-readable storage medium uploaded with computer-readable program instructions for performing various aspects of the present disclosure.

The computer-readable storage medium may be a tangible device that maintains and stores instructions used to instruct execution devices. The computer-readable storage medium, for example, may be—but is not limited to—an electrical storage device, magnetic storage device, optical storage device, electromagnetic storage device, semiconductor memory device, or any suitable combination of the above. More specific examples of the computer-readable storage medium (a non-exhaustive list) comprise: random access memory (RAM), read-only memory (ROM), erasable programmable read-only memory (EPROM or flash memory), static random access memory (SRAM), and any suitable combination of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions for performing operations of the present disclosure can be assembly instructions, instruction set architecture instructions, machine instructions, machine-dependent instructions, microcode, firmware instructions, state-setting data, or source code or object code written in any combination of one or more programming languages, wherein the programming languages comprise object-oriented programming languages—such as Smalltalk, C++, etc.—and conventional procedural programming languages—such as the “C” programming language or similar programming languages. Computer-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of computer-readable program instructions is used to personalize custom electronic circuits, such as a programmable logic circuit, field-programmable gate array (FPGA) or programmable logic array (PLA), wherein the electronic circuit is able to execute computer-readable program instructions, thereby achieving the various aspects of the present disclosure.

Various aspects of the present disclosure are described herein with reference to flow charts and/or block diagrams depicting methods, apparatus (systems), and computer program products according to the examples of the present disclosure. It should be understood that every block in the flow charts and/or block diagrams and the combinations of various blocks in the flow charts and/or block diagrams may be implemented by computer-readable program instructions.

These computer-readable program instructions may be provided to general-purpose computers, dedicated computers or the processing units of other programmable data processing apparatuses, thereby producing a type of machine, such that when these instructions are executed by the computers or processing units of other programmable data processing apparatuses, an apparatus that realizes the functions/actions stipulated in one or more boxes in the flow charts and/or block diagrams is produced. These computer-readable program instructions may also be stored in computer-readable storage medium, enabling computers, programmable data processing apparatuses, and/or other devices to operate in a specific manner. Therefore, the computer-readable media containing instructions comprise a manufactured product that comprises instructions for implementing various aspects of the functions/actions specified in one or more boxes in the flow charts and/or block diagrams.

The computer-readable program instructions may also be loaded onto a computer, other programmable data processing apparatuses, or other devices, enabling a series of operational steps to be executed on the computer, other programmable data processing apparatuses, or other devices to generate a computer-implemented process. This enables the instructions executed on the computer, other programmable data processing apparatuses, or other devices to implement the functions/actions specified in one or more boxes in the flow charts and/or block diagrams.

The flow charts and block diagrams in the accompanying drawings show the system architecture, functions and operations that may be implemented based on the system, method and computer program product according to the plurality of examples of the present disclosure. Regarding this, every block in the flow chart or block diagram can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The terms used herein are chosen to best explain the principles and practical application of the various examples or the improvements in the technology in the market, or allow others of ordinary skill in the art to understand the various examples disclosed herein.

What is claimed is:

1. A method for driving a vehicle, comprising:
controlling the vibration of the vehicle through an active suspension of the vehicle according to a control instruction;
applying a compensation torque to the vehicle in response to the vehicle being vibrated; and
driving the vehicle based at least on the compensation torque.

2. The method according to claim 1, the method further comprising before controlling the vibration of the vehicle through the active suspension of the vehicle:
acquiring the rotation speed and driving speed of the tires of the vehicle according to a user instruction;
determining the absolute value of the difference between the rotation speed and the driving speed as the slip speed;
determining the ratio of the slip speed to the driving speed as the slip ratio;
detecting whether the slip ratio is greater than a first threshold; and
in response to the slip ratio being greater than the first threshold, providing the control instruction.

3. The method according to claim 2, the method further comprising before controlling the vibration of the vehicle through the active suspension of the vehicle:
presenting a prompt to the user to use a first driving function; and
in response to the user accepting the prompt, providing the user instruction.

4. The method according to claim 1, wherein the vehicle is provided with a vibration period and a maximum amplitude, and wherein controlling the vibration of the vehicle through the active suspension of the vehicle comprises:
controlling the vibration of the vehicle through the active suspension according to a dynamic amplitude, wherein the magnitude of the dynamic amplitude is positively correlated with time; and
in response to the dynamic amplitude being equal to the maximum amplitude, controlling the vibration of the vehicle through the active suspension according to the maximum amplitude.

5. The method according to claim 4, wherein in response to the vehicle being vibrated, applying a compensation torque to the vehicle comprises:
starting at a first moment when the active suspension vibrates from a peak to a trough, continuously applying a compensation torque to the vehicle; and
starting at a second moment when the active suspension vibrates from a trough to a peak, stopping applying a compensation torque to the vehicle.

6. The method according to claim 5, wherein continuously applying a compensation torque to the vehicle comprises determining the compensation torque based at least on the maximum amplitude, and wherein the magnitude of the compensation torque is positively correlated with the maximum amplitude.

7. The method according to claim 5, wherein continuously applying a compensation torque to the vehicle comprises:
measuring the height of the vehicle at a current moment and the height at a previous moment;
determining the vibration speed of the vehicle based on the height at the current moment and the height at the previous moment; and
determining the compensation torque based at least on the vibration speed, wherein the magnitude of the compensation torque is positively correlated with the vibration speed of the vehicle.

8. The method according to claim 4, wherein in response to the vehicle being vibrated, applying a compensation torque to the vehicle comprises:
continuously applying the compensation torque to the vehicle at a first distance before the active suspension vibrates to a trough; and
stopping applying the compensation torque to the vehicle at a second distance before the active suspension vibrates to a peak.

9. The method according to claim 4, further comprising:
using a sensor to measure the distance between the vehicle and a target object under the vehicle; and
determining the maximum amplitude based on the distance, wherein the maximum amplitude is less than the distance.

10. The method according to claim 1, further comprising:
in response to receiving a stop instruction from a user, stopping applying the compensation torque to the vehicle.

11. An apparatus for driving a vehicle, comprising:
a vibration module configured to control the vibration of the vehicle through the active suspension of the vehicle according to a control instruction;
a compensation torque module configured to apply a compensation torque to the vehicle in response to the vehicle being vibrated; and
a drive module configured to drive the vehicle based at least on the compensation torque.

12. A controller, comprising:
at least one processor, and
a memory, coupled to the at least one processor, and having instructions stored thereon that, when executed by the at least one processor, cause the controller to perform the method according to claim 1.

13. A vehicle, comprising the controller according to claim 12.

14. A computer program product, tangibly stored on a non-transitory computer-readable medium and comprising machine-executable instructions, wherein the machine-executable instructions, when executed, cause the machine to execute the method according to claim 1.
